(19) United States
(12) Patent Application Publication
(10) Pub. No.: US 2006/0239684 A1
(43) Pub. Date: Oct. 26, 2006

(54) Optical add/drop device, optical add/drop system, and optical signal add/drop method

(75) Inventor: Takefumi Oguma, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/407,056

(22) Filed: Apr. 20, 2006

(30) Foreign Application Priority Data
Apr. 26, 2005 (JP) 128122/2005

(51) Int. Cl. H04J 14/02

(52) U.S. Cl. 398/83

(57) ABSTRACT

An optical add/drop device, an optical add/drop system, and method thereof is provided herein. The optical add/drop system may include, a first variable coupler which splits input light to through light and dropped light, a wavelength blocker which attenuates an intensity of each channel of the through light, a second variable coupler which couples the through light from the wavelength blocker and added light, and a dropped light detector which measures an intensity of the dropped light. Further, the system may include an added light detector which measures an intensity of the added light, a through light detector which measures an intensity of the each channel of the through light from the wavelength blocker, and a controller which controls the first variable coupler, controls the wavelength, and controls the second variable coupler.

### CROSS REFERENCE TO RELATED APPLICATIONS

This application claims priority from Japanese Patent Application No. 128122/2005, filed Apr. 26, 2005 in the Japanese Patent Office, the entire disclosure of which is incorporated by reference.

### BACKGROUND OF THE INVENTION

The present invention relates to an optical add/drop device, an optical add/drop system, and an optical signal add/drop method, for multiplexing optical signals with different wavelengths and for separating particular wavelengths from the multiplexed optical signals.

In the field of optical communications, a multiplexing technology known as the wavelength division multiplexing (WDM) is commonly used which increases the information transmission capacity by multiplexing a plurality of optical signals which have different wavelengths and then transmitting the multiplexed signal.

A WDM optical communication system requires an “optical add/drop system” (also known as optical add/drop multiplexer system (OADM)) in order to drop particular wavelengths from the main signal or add particular wavelengths to the main signal.

As an optical add/drop system according to the prior art, “Method and optical device for filtering input wavelength division multiplexing (WDM) signals having N wavelength channels” is disclosed by Japanese Laid-Open Patent No. 323683/2002, which provides an optical add/drop system that blocks the signals whose wavelengths are the same as that of added signal by means of a wavelength blocker provided in the through path of the main signal, in order to prevent a interference between the main signal and the added signal.

The optical add/drop systems using a wavelength blocker as disclosed in Japanese Laid-Open Patent No. 323683/2002 has many advantages, such as allowing the implementation of low-cost and fully reconfigurable optical add/drop, compared with optical add/drop systems using an arrayed waveguide grating (AWG) or a dielectric optical filter. However, in the add/drop system of Japanese Laid-Open Patent No. 323683/2002, there is a problem of tradeoff between the dynamic range of the drop side when the input signal level is low and the loss between the input and the output of the add/drop system, since added/dropped light and transmitted light are added and dropped by an optical coupler.

Thus, the optical add/drop systems using a wavelength blocker has a problem that a variation in optical level of the input light results in a loss between input and output, and causes the receiving dynamic range of a dropped signal to be narrowed.

### SUMMARY OF THE INVENTION

One of the objects of the invention is to provide an optical add/drop device, an optical add/drop system, and an optical signal add/drop method, wherein, even if optical level of input lightvaries, the loss between input and output is small, and also the receiving dynamic range of dropped light is large.

According to an aspect of the present invention, it is possible to provide an optical add/drop device, an optical add/drop system, and an optical add/drop method wherein, even if an optical level variation occurs, the input-output loss is small and the receiving dynamic range is large.

According to an aspect of the present invention, the optical add/drop device includes, a first variable coupler which receives an input optical signal having a plurality of channels and splits the input optical signal to a through optical signal and a dropped optical signal, a wavelength blocker which attenuates an intensity of each channel of the through optical signal, a second variable coupler which couples the through optical signal from the wavelength blocker with an added optical signal, a dropped optical signal detector which measures an intensity of the dropped optical signal that is dropped by the first variable coupler, an added optical signal detector which measures an intensity of the added optical signal, and a through optical signal detector which measures an intensity of the each channel of the through optical signal from the wavelength blocker.

According to another aspect of the present invention, the optical add/drop device includes, a first variable coupler which receives an input optical signal having a plurality of channels and splits the input optical signal to a through optical signal and a dropped optical signal, a wavelength blocker which attenuates an intensity of each channel of the through optical signal, a variable attenuator which attenuates an added optical signal, an optical coupler which couples the through optical signal from the wavelength blocker with the added optical signal from the variable attenuator, a dropped optical signal detector which measures an intensity of the dropped optical signal, an added optical signal detector which measures an intensity of the added optical signal, and a through optical signal detector which measures an intensity of the each channel of the through optical signal from the wavelength blocker.

According to another aspect of the present invention, the optical add/drop device includes, a first variable coupler which receives an input optical signal having a plurality of channels and splits an input optical signal to a through optical signal and a dropped optical signal, a wavelength blocker which attenuates an intensity of each channel of the through optical signal, a second variable coupler which couples the through optical signal from the wavelength blocker with an added optical signal and outputs an output optical signal having a plurality of channels, an input optical signal detector which measures an intensity of the input optical signal, a dropped optical signal detector which measures an intensity of the dropped optical signal that is dropped by the first variable coupler, and an output optical signal detector which measures an intensity of the each channel of the output light from the second variable coupler.

According to another aspect of the present invention, the optical add/drop system includes, a first variable coupler which receives an input optical signal having a plurality of channels and splits the input optical signal to a through optical signal and a dropped optical signal, a wavelength blocker which attenuates an intensity of each channel of the through optical signal, a second variable coupler which couples the through optical signal from the wavelength blocker with an added optical signal and outputs an output optical signal having a plurality of channels, a dropped optical signal detector which measures an intensity of the dropped optical signal that is dropped by the first variable coupler, an added optical signal detector which measures an intensity of the added optical signal, a through optical signal detector which measures an intensity of the each channel of the through optical signal from the wavelength blocker, and a controller which controls the first variable coupler based on the result of the measurement of the dropped optical signal detector, controls the wavelength blocker based on the measurement of the through optical signal detector, and controls the second variable coupler based on the result of the measurement of the through optical signal detector and the added optical signal detector.

According to another aspect of the present invention, the optical add/drop system includes, a first variable coupler which receives an input optical signal having a plurality of channels and splits the input optical signal to through optical signal and dropped optical signal, a wavelength blocker which attenuates an intensity of each channel of the through optical signal, a variable attenuator which attenuates an added optical signal, an optical coupler which couples the through optical signal from the wavelength blocker with the added optical signal from the variable attenuator, a dropped optical signal detector which measures an intensity of the dropped optical signal, an added optical signal detector which measures an intensity of the added optical signal, a through optical signal detector which measures an intensity of the each channel of the through optical signal from the wavelength blocker, and a controller which controls the first variable coupler based on the result of the measurement of the dropped optical signal detector, controls the wavelength blocker based on the measurement of the through optical signal detector, and controls the variable attenuator based on the result of the measurement of the through optical signal detector and the added optical signal detector.

According to another aspect of the present invention, the optical add/drop method in an optical add/drop system including a first variable coupler which receives an input optical, signal having a plurality of channels and splits the input optical signal to a through optical signal and a dropped optical signal, a wavelength blocker which attenuates an intensity of each channel of the through optical signal, a second variable coupler which couples the through optical signal from the wavelength blocker with an added optical signal, the method includes, measuring an intensity of the dropped optical signal, adjusting a splitting ratio of the first variable coupler, which splits the through optical signal and the dropped optical signal according to the splitting ration that is adjusted, based on the measured intensity of the dropped optical signal, measuring an intensity of each channel of the through optical signal, adjusting an amount of attenuation of the through optical signal by the wavelength blocker based on the measured intensity of each channel of the through optical signal, measuring an intensity of the added optical signal, and adjusting a coupling ratio of the second variable coupler, which couples the through optical signal and the added optical signal according to the coupling ratio which is adjusted, based on the measured intensity of the added optical signal.

According to another aspect of the present invention, the optical add/drop method in an optical add/drop system including a first variable coupler which receives an input optical signal having a plurality of channels and splits the input optical signal to a through optical signal and a dropped optical signal, a wavelength blocker which attenuates an intensity of each channel of the through optical signal, a variable attenuator which attenuates an added optical signal, and an optical coupler which couples the through optical signal from the wavelength blocker with the added optical signal from the variable attenuator, the method includes, measuring an intensity of the dropped optical signal, adjusting a splitting ratio of the first variable coupler, which splits the through optical signal and the dropped optical signal according to the splitting ration that is adjusted, based on the measured intensity of the dropped optical signal, measuring an intensity of each channel of the through optical signal, adjusting an amount of attenuation of the through optical signal by the wavelength blocker based on the measured intensity of each channel of the through optical signal, measuring an intensity of the added optical signal, and adjusting an amount of attenuation of the variable attenuator based on the measured intensity of the added optical signal.

### BRIEF DESCRIPTION OF THE DRAWINGS

FIG. 1 is a schematic illustrating a configuration of an optical add/drop system using a wavelength blocker and a variable attenuator.

FIG. 2 is a schematic illustrating a configuration of an optical add/drop system according to a first exemplary embodiment of the present invention.

FIG. 3 is a flowchart showing the operation process of the optical add/drop system of the first exemplary embodiment.

FIG. 4 is a diagram showing a variation in dropped light relative to a variation in input light level of the optical add/drop system of the first exemplary embodiment.

FIG. 5 is a diagram showing an input-output loss of the optical add/drop system of the first exemplary embodiment.

FIG. 6(a) is a diagram showing an optical add/drop system and an optical amplifier.

FIG. 6(b) is a diagram showing an optical add/drop system and an optical amplifier.

FIG. 7 is a schematic illustrating a configuration of an optical add/drop system according to a second exemplary embodiment of the present invention.

FIG. 8 is a flowchart showing the operation process of the optical add/drop system of the second exemplary embodiment.

FIG. 9 is a diagram showing an input-output loss of the optical add/drop system of the second exemplary embodiment.

FIG. 10 is a schematic illustrating a configuration of an optical add/drop system according to a third exemplary embodiment of the present invention.

FIG. 11 is a diagram showing the operation process of the optical add/drop system of the third exemplary embodiment.

FIG. 12 is a schematic showing another example configuration of the optical add/drop system of the third exemplary embodiment.

FIG. 13 is a schematic illustrating an example configuration of an optical add/drop system that detects the level of input light or through light using a wavelength-independent photodetector.

### DETAILED DESCRIPTION OF EXEMPLARY EMBODIMENTS

Hereinafter, exemplary embodiments of the present invention will now be described in detail with reference to the accompanying drawings. The described exemplary embodiments are intended to assist in understanding the invention, and are not intended to limit the scope of the invention in any way.

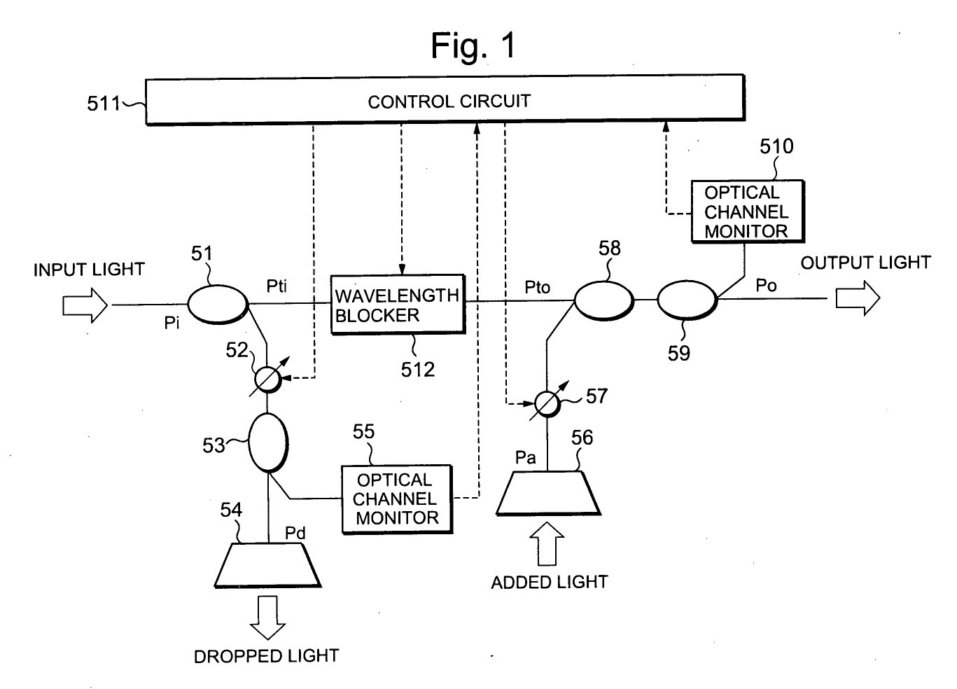

In order to reduce a loss between input and output (an input-output loss), a variable attenuator may be added to each of the drop and add sides of an optical add/drop system in the related art using a wavelength blocker has been considered, as shown in FIG. 1. In this configuration, if the input signal level is sufficiently high, it is possible to attenuate dropped light to be output from a drop-side add/drop device 54 and added light inputted via an add-side add/drop device 56 to a predetermined level, by controlling the attenuation ratio of a variable attenuator 52 and a variable attenuator 57 with a control unit 511. As a result, the input-output loss is maintained at a predetermined level if the input signal level is sufficiently high.

However, since the variable attenuator 52 and variable attenuator 57 can adjust the loss simply by attenuating a signal (in other words, the attenuation ratio cannot exceed 0 dB), there is a limit to the adjustment. If the input signal level decreases beyond the limit, it is no longer possible to maintain dropped light at a desired level.

Therefore, adding a variable attenuator to each of the drop and add sides only results in a decreased receiving dynamic range in response to a change in the level of input light.

Therefore, in accordance with an aspect of the present invention, an optical add/drop system is configured so that the following conditions are satisfied, in order to prevent a decrease in dynamic range in response to a change in the level of input light:
(1) a variable optical coupler is used for at least dropping dropped light from input light. For added light, either a variable optical coupler may be used for combining added light with through light, or the through light and added light may be combined via a variable attenuator.
(2) At least the signal level of each channel of input light and output light is monitored, and based on the result of the monitoring a splitting ratio of a drop-side variable optical coupler, a coupling ratio of an add-side variable optical coupler (or attenuation ratio of a variable attenuator), and an attenuation ratio of each channel at a wavelength blocker are controlled.

In a WDM system, each of the multiplexed channels may be provided at a different wavelength. This realizes an optical add/drop system with large dynamic range in response to a change in the level of input light.

Exemplary embodiments based on the aforementioned principle are described below. Hereinafter, light may include an optical signal.

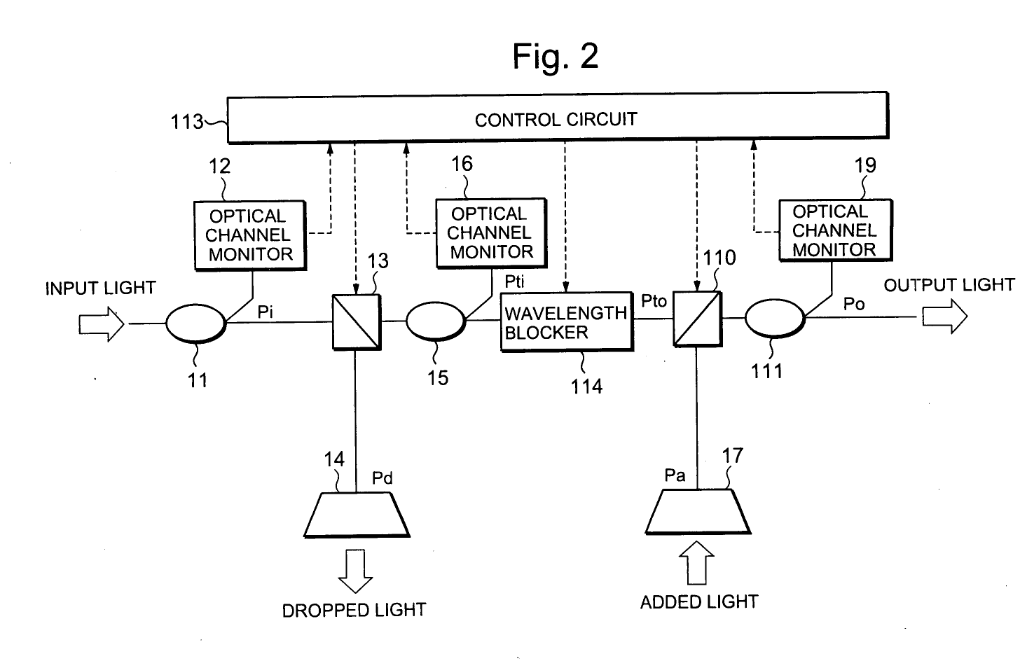

A first exemplary embodiment according to the present invention is described. FIG. 2 shows the configuration of an optical add/drop system according to this exemplary embodiment.

This optical add/drop system comprises a tap coupler 11, an optical channel monitor 12, a drop-side variable optical coupler 13, a drop-side optical add/drop device 14, a tap coupler 15, an optical channel monitor 16, a wavelength blocker 114, an add-side variable optical coupler 110, an add-side add/drop device 17, a tap coupler 111, and an optical channel monitor 19.

The tap coupler 11 taps a portion of input light and outputs it to the optical channel monitor 12. The optical channel monitor 12 monitors the level of input light. The drop-side variable optical coupler 13 separates input light into through light and dropped light at an arbitrary rate. Signals of through light channels and those of dropped light channels have the same information as the input light, and only the intensity is different. That is, the drop-side variable optical coupler 13 branches each input light at an arbitrary intensity rate, without changing each channel component. The drop-side optical add/drop device 14 branches dropped light for each channel. The tap coupler 15 taps part of through light and inputs them to the optical channel monitor 16. The optical channel monitor 16 monitors the level of through side output light of the drop-side variable optical coupler 13. The wavelength blocker 114 tunes or blocks the level of arbitrary channels of through light. The add-side variable optical coupler 110 combines through light and added light at an arbitrary rate and outputs the combined through light and added light. The add-side add/drop device 17 combines added light for each channel. The tap coupler 111 taps a portion of output light and inputs it to the optical channel monitor 19. The optical channel monitor 19 monitors the level of output light.

The operation of the add/drop system along the light signal stream will be explained below.

In FIG. 2, input light from the left of the drawing partially separated by the tap coupler 11, and the separated light enters the optical channel monitor 12.

The optical channel monitor 12 comprises a wavelength splitting device, such as an AWG, and a photodetector. The optical monitor 12 splits input light into each channel and monitors the level of each channel. Any known monitor can be used as the optical channel monitor 12.

The optical channel monitor 12 detects the level (Pi) of input light to the drop-side variable optical coupler 13.

The drop-side variable optical coupler 13 may be, for example, a variable coupler using a Mach-Zehnder type optical circuit. As for the control, a TO (thermo-optic effect) type or electro-optic effect type may be used. Also, a polarizing device (e.g. liquid crystal) or other known variable optical couplers may be used.

The dropped light separated by the drop-side variable optical coupler 13 enters the drop-side optical add/drop device 14. The drop-side optical add/drop device 14 may be, for example, an AWG type wavelength add/drop device and splits the dropped light into each channel and outputs the split light. Also, the drop-side add/drop device may comprise a Fiber Bragg Grating (FBG) and an optical circulator.

Part of through light outputted from the drop-side variable optical coupler 13 enters the channel monitor 16 through the tap coupler 15. The channel monitor 16 monitors the output of the through side of the drop-side variable optical coupler 13. Any known monitor can be employed as the channel monitor 16, as in the case of the channel monitor 12.

The channel monitors 12 and 16 may comprise a diffraction grating and a photodetector, or a band-pass element and a photodetector, in addition to the exemplary configuration of a wavelength splitting device and a photodetector described above. If a diffraction grating is used, the channel monitor may be configured so that the wavelength of light input to the photodetector may be varied by rotating the incident angle from the diffraction grating. The diffraction grating which can diffract by fixed amount as well as the diffraction grating which can diffract by variable amount may be used. In case of the variable diffraction device, the control circuit 113 may control the amount of diffraction of the device. On the other hand, in the case that a band-pass element is used, a photodetector may be disposed at the stage subsequent to the band-pass element and a central wavelength of the transmitting signal may be varied by rotating the band-pass element. A band-pass filter, for example, a dielectric wavelength variable optical band-pass filter, or a waveguide type variable optical band-pass filter, may be used as the band-pass filter element.

In addition to these examples, any configuration allowing the measurement of the level of light signal of each channel can be used as the channel monitor 12 or 16.

The through light outputted from the tap coupler 15 enters into the wavelength blocker 114. The wavelength blocker 114 may be, for example, a device having the function of 1×1 type optical wavelength switch+variable optical attenuator, i.e., a combination of diffraction grating and liquid crystal, and attenuates and blocks each channel of through light. Specifically, the wavelength blocker has a function of compensating for level deviation among each channel of received signal light, and a function of blocking the received signal light, if necessary, so that added light will not collide with through light. Any known wavelength blocker can be used as the wavelength blocker 114.

The light outputted from the wavelength blocker 114 enters into the add-side variable optical coupler 110. The add-side variable optical coupler 110 may be the one having a configuration similar to the drop-side variable optical coupler 13.

The light to be added by the optical add/drop system (added light) is coupled by the add-side optical add/drop device 17. The add-side optical add/drop device 17 may, for example, comprise an AWG, as in the case of the drop-side optical add/drop device 14. In the case where the number of channels is 16 or less, however, a star coupler may be employed.

The added light coupled by the add-side optical add/drop device 17 enters into the add-side variable optical coupler 110.

The through light and added light coupled by the add-side variable optical coupler 110 are output via the tap coupler 111. The tap coupler 111 separates part of the output light and enters them to the optical channel monitor 19. The optical channel monitor 19 monitors the output light of the optical add/drop system. Any known configuration can be employed for the channel monitor 19, as in the case of the channel monitor 12 or 16.

The control circuit 113 holds the information (through/block information) that indicates which wavelength channel of the light is, to be blocked by the wavelength blocker 114 and which wavelength channel of the light is to be transmitted through the add/drop system. This makes it possible to find which wavelength channel of the light is to be recognized as through light among the channels detected by the optical channel monitor 19, based on the information about each channel detected by the optical channel monitor 12 and the through/block information for the wavelength blocker 114 stored in the control circuit 113. Furthermore, the control circuit 113 holds the information (transponder mounting information) that indicates which wavelength channel of the light is to be input as added light to the add-side optical add/drop device 17. This makes it possible to find which wavelength channel of the light is to be recognized as added light among the channels detected by the optical channels monitor 19.

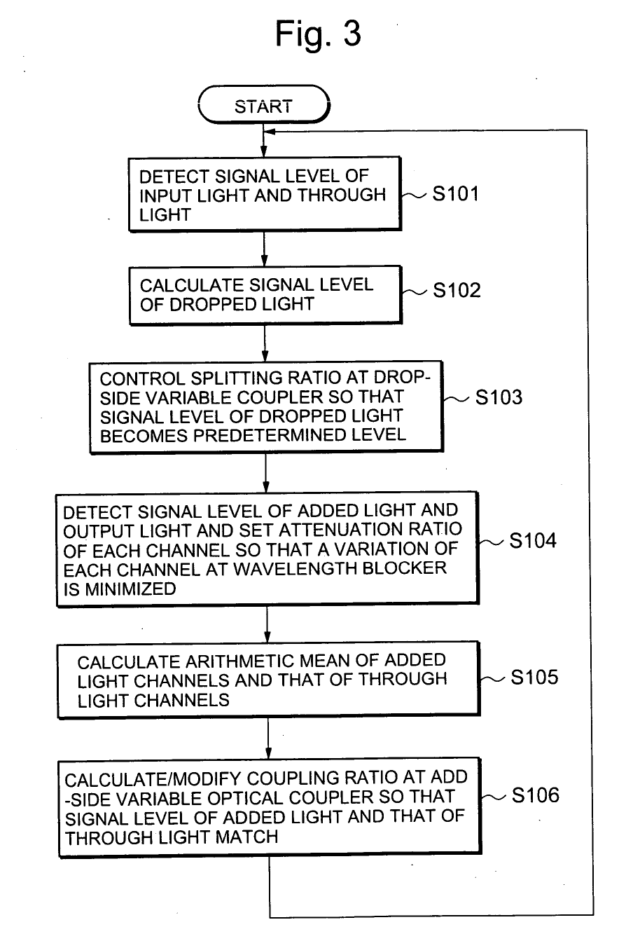

Now, the operation of the optical add/drop system is described. FIG. 3 shows the operation process of an optical add/drop system according to this exemplary embodiment.

The results of the optical channel monitors 12 and 16 are input to the control circuit 113 (S101). Then, the control circuit 113 performs the following arithmetic operations (S102):
(1) Calculation of an arithmetic mean (Pi) of the optical levels of respective input light channels detected by the optical channel monitor 12.
(2) Calculation of an arithmetic mean (Pti) of the optical levels of respective through light channels detected by the optical channel monitor 16.
(3) Calculation of a loss (Pti−Pi) of the through side of the drop-side variable optical coupler 13.
(4) Calculation of a loss, 10 log(1−10^{(Pti-Pi/10)}), of the drop side of the drop-side variable optical coupler 13.
(5) Calculation of the signal level, (Pd=Pi+10 log(1−10^{(Pti-Pi/10)}), of dropped light.

The control circuit 13 sends a control signal for adjusting the splitting ratio of the drop-side variable optical coupler 13 to the drop-side variable optical coupler 13, so that the dropped signal level matches a preset target value (S103).

The result of the optical channel monitor 19 is input to the control circuit 113. Then, the control circuit 113 sends a control signal to the wavelength blocker 114, so that a variation in the level of through light of the output light detected by the optical channel monitor 19 is minimized (i.e., matches a preset target value) (S104).

Thereafter, the control circuit 113 calculates an arithmetic mean (Poa) of the optical levels of respective added light channels, and an arithmetic mean (Pot) of the optical levels of respective through light channels (S105).

Then, the control circuit 113 sends a control signal for, adjusting the splitting ratio of the add-side variable optical coupler 110 to the add-side variable optical coupler 110, so that Poa is equal to Pot (S106).

The control circuit 113 repeats the steps S101 through S106 described above.

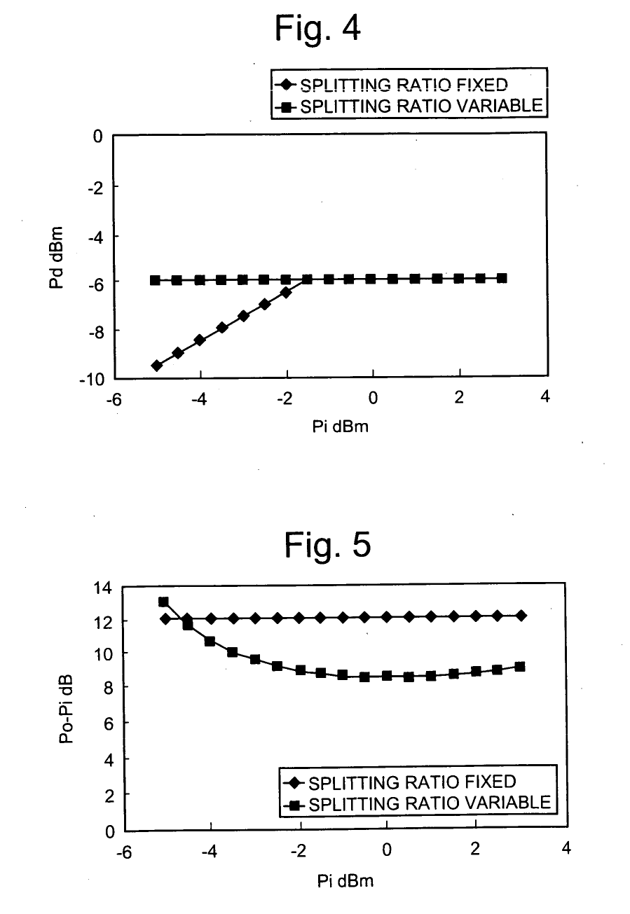

FIG. 4 shows the relationship between the level of the input light and the level of the dropped light in the add/drop system both in the related art and in this exemplary embodiment. FIG. 5 shows the relationship between the level of the input light and the input-output loss through the add/drop system both in the related art and in this exemplary embodiment. In FIG. 4, the target value of the optical level of dropped light is −6 dBm.

As shown in FIG. 4, in the optical add/drop system configured as shown in FIG. 5, if the intensity of input light falls below −1 dBm, the optical level of dropped light falls below the target value of −6 dBm (dropped light cannot be detected). In contrast, in the optical add/drop system according to this exemplary embodiment, the optical level of added light is maintained at the target value regardless of the optical level of input light.

Furthermore, it can be seen from FIG. 5 that, when the optical level of input light is at −4 dBm or more, the input-output loss is smaller than when a variable optical coupler is not used as explained in this exemplary embodiment. The input-output loss of the optical add/drop system of this exemplary embodiment shown in FIG. 4 is a value in the case where the wavelength blocker 114 does not attenuate the intensity of each channel at all. Since the attenuation ratio of each channel in the wavelength blocker 114 can be arbitrarily set, it is easy to increase the input-output loss to larger than the value shown in the figure by attenuating each channel in the wavelength blocker 14. That is, in the range where the input light is at −4 dBm or more, it is possible to maintain the input-output loss at the same level (−12 dB) as that of the optical add/drop-system shown in FIG. 1.

As shown in these figures together, the optical add/drop system according to this exemplary embodiment increases the receiving dynamic range from −1 dBm in the configuration shown in FIG. 1 to −4 dBm, while keeping the input-output loss above the threshold (in this example, —12 dB).

In the optical add/drop system according to this exemplary embodiment, the control unit 113 changes the splitting ratio of the drop-side variable optical coupler 13 when the level of input light changes so that the dropped light level is kept constant. By this configuration, the dropped light level will be kept constant even if the input light level changes. Thus, it is possible to increase the receiving dynamic range in response to a change in the input light level.

Also, if the tap coupler is disposed at the drop side as in the optical add/drop system shown in FIG. 1, the dynamic range is reduced due to the loss by the tap coupler itself. However, if the tap coupler 51 is placed at the through side as in the optical add/drop system of this exemplary embodiment and the level of dropped light is determined indirectly (as dropped light=input light−through light), the loss of the drop side is reduced and thereby the dynamic range is increased.

Moreover, since the splitting ratio of the add-side variable optical coupler is adjusted according to the splitting ratio of the drop-side variable optical coupler, the level of the through light and that of the added light can be matched without an excess loss by means of a variable attenuator.

Thus, according to the optical add/drop system of this exemplary embodiment, even if the input light level changes, it is possible to increase the receiving dynamic range of dropped light while maintaining the input-output loss at a low level.

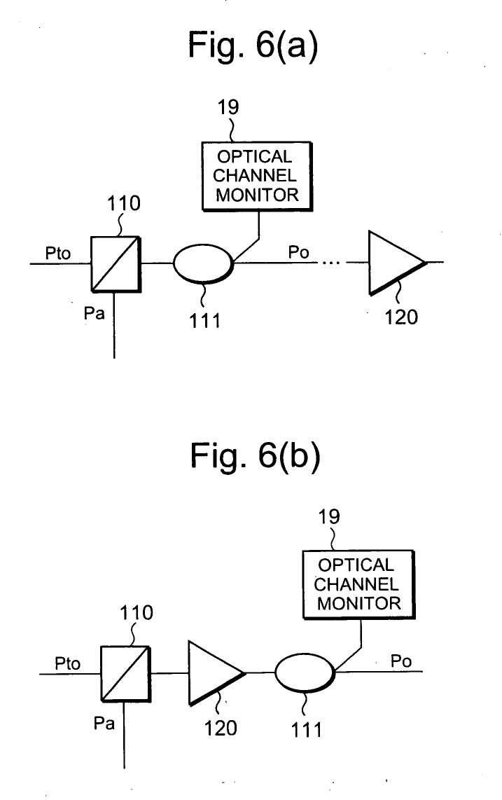

As shown in FIG. 6(a), an optical amplifier 120 is generally disposed at the stage subsequent to the optical add/drop system. However, the optical amplifier may be placed within the optical add/drop system (at the stage prior to the optical channel monitor 19 (tap coupler 111) that monitors output light), as shown in FIG. 6(b). When the optical amplifier amplifies signals, variations in gain among channels are caused. These variations in gain among channels caused at the optical amplifier 120 can be suppressed by adjusting the levels with the wavelength blocker 114. Thus, it is possible to transmit uniformly-leveled optical signals for respective channels to devices at subsequent stages. This configuration may apply to the optical add/drop systems according to other exemplary embodiments.

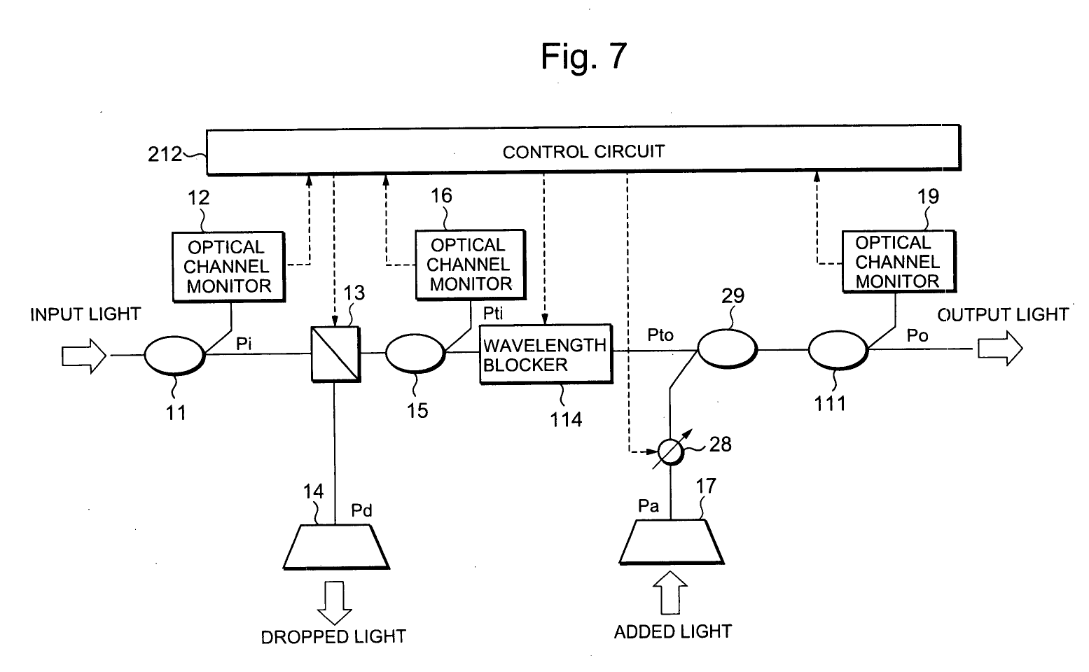

A second exemplary embodiment according to the present invention is described below. FIG. 7 shows the configuration of an optical add/drop system of this exemplary embodiment.

The optical add/drop system according to this exemplary embodiment is similar to the first exemplary embodiment, but has a variable attenuator 28 and a tap coupler 29, instead of the variable coupler 110, at the output side. In this exemplary embodiment, the variable attenuator 28 and the tap coupler 29 act as the variable optical coupler 110. A control circuit 212 holds the information (through/block information) indicating which wavelength channel of the light is to be blocked by a wavelength blocker 114 and the information (transponder mounting information) indicating which wavelength channel of the light is to be input as added light, as in the first exemplary embodiment. The control circuit 212 outputs a control signal to a drop-side variable optical coupler 13, the wavelength blocker 114, and a variable attenuator 28 to change the splitting ratio or attenuation ratio.

The other components are the same as those of the first exemplary embodiment.

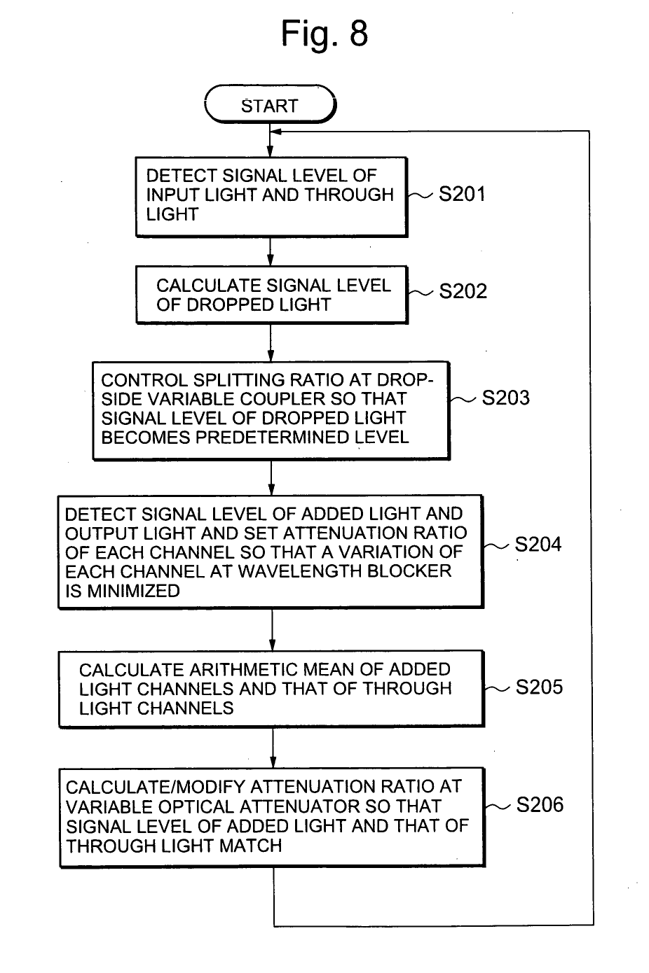

The operation of the optical add/drop system according to this exemplary embodiment is described. FIG. 8 shows the operation process of an optical add/drop system according to this exemplary embodiment.

The results of the optical channel monitors 12 and 16 are input to the control circuit 212 (S101). Then, the control circuit 212 performs the following arithmetic operations (S202):
(1) Calculation of an arithmetic mean (Pi) of the optical levels of respective input light channels detected by the optical channel monitor 12.
(2) Calculation of an arithmetic mean (Pti) of the optical level of respective through light channels detected by the optical channel monitor 16.
(3) Calculation of a loss (Pti−Pi) of the through side of the drop-side variable optical coupler 13.
(4) Calculation of a loss (10 log(1−10^{) (Pti-Pi/10)} of the drop side of the drop-side variable optical coupler 13.
(5) Calculation of the signal level (Pd=Pi+10 log(1−10^{((Pti-Pi)/10)}) of dropped light.

The control circuit 212 sends a control signal for adjusting the splitting ratio of the drop-side variable optical coupler 13 to the drop-side variable optical coupler 23, so that the above signal level matches a preset target value (S203).

The result of the optical channel monitor 19 is input to the control circuit 212. Then, the control circuit 212 sends a control signal to the wavelength blocker 114, so that a variation in the level of through light of the output light detected by the optical channel monitor 19 is minimized (i.e., matches a preset target value) (S204).

Thereafter, the control circuit 212 calculates an arithmetic mean (Poa) of the optical levels of respective added light channels, and an arithmetic mean (Pot) of the optical levels of respective through light channels (S205).

Then, the control circuit 212 sends a control signal to the variable attenuator 28 so that Poa is equal to Pot (S206).

The control unit 212 repeats the steps S201 through S206 described above.

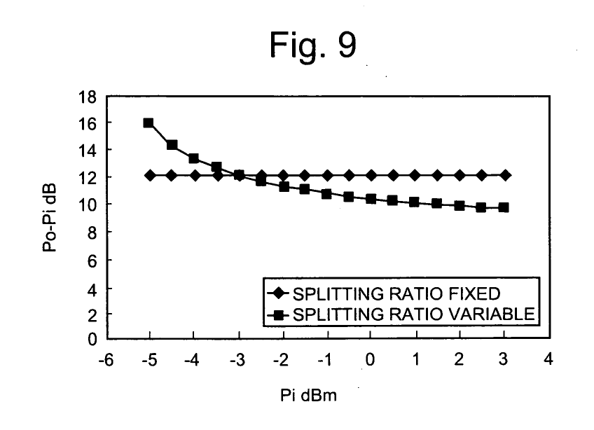

FIG. 9 shows the input-output loss of an optical add/drop system of this exemplary embodiment.

As shown in FIG. 9, it can be seen that the optical add/drop system according to this exemplary embodiment has a smaller input-output loss than related systems when the optical level of input light is at −3 dBm or greater. As described in the first exemplary embodiment, since the input-output loss may be increased easily by controlling the wavelength blocker 114, if the input light level is at −3 dBm or greater, it is possible to increase the optical level of dropped light while maintaining the input-output loss at values similar to the values in the related art.

In this exemplary embodiment, the minimum add-output loss is greater than in the first exemplary embodiment, but the add-side loss inherently has a margin and therefore such a system configuration is also effective.

Thus, the optical add/drop system according to this exemplary embodiment also changes the splitting ratio of the drop-side variable optical coupler in response to variations in input optical level, so that the optical level of dropped light can be maintained constant regardless of a variation in input optical level.

Furthermore, since the splitting ratio of the add-side variable coupler is optimized according to the splitting ratio of the drop-side variable coupler, the input-output loss is maintained low.

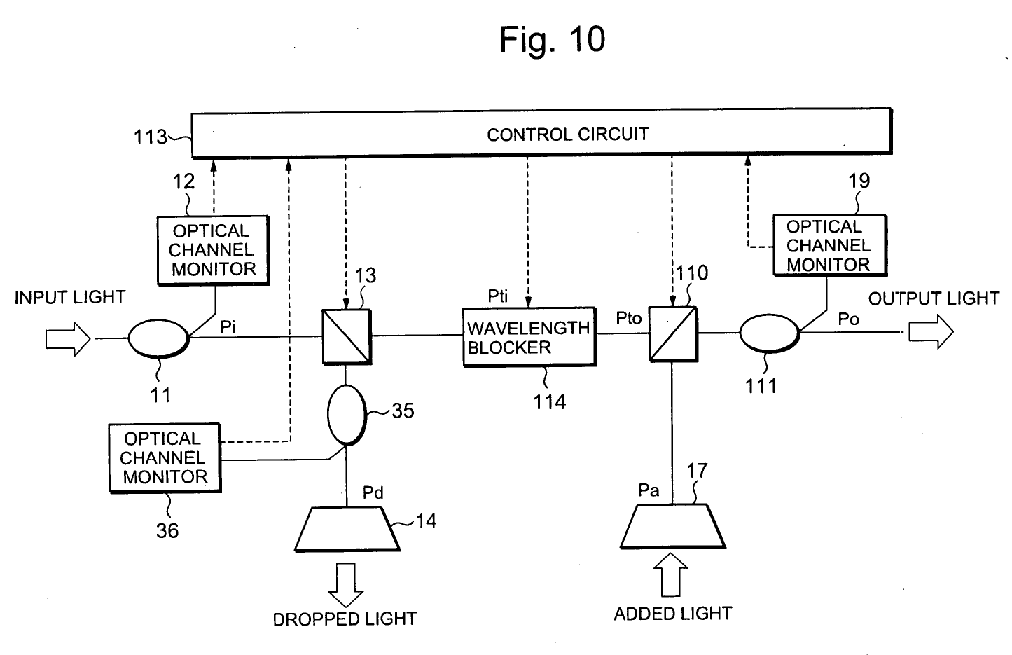

A third exemplary embodiment of the present invention is described below. FIG. 10 shows the configuration of an optical add/drop system according to, this exemplary embodiment. The configuration of this system is almost the same as that of the first exemplary embodiment, except that a tap coupler 35 and an optical channel monitor 36 are provided instead of the tap coupler 15 and the channel monitor 16. The tap coupler 35 is disposed between a drop-side variable optical coupler 13 and a drop-side add/drop device 14, and taps part of dropped light and inputs it to the channel monitor 36. The optical channel monitor 36 monitors the level of dropped light.

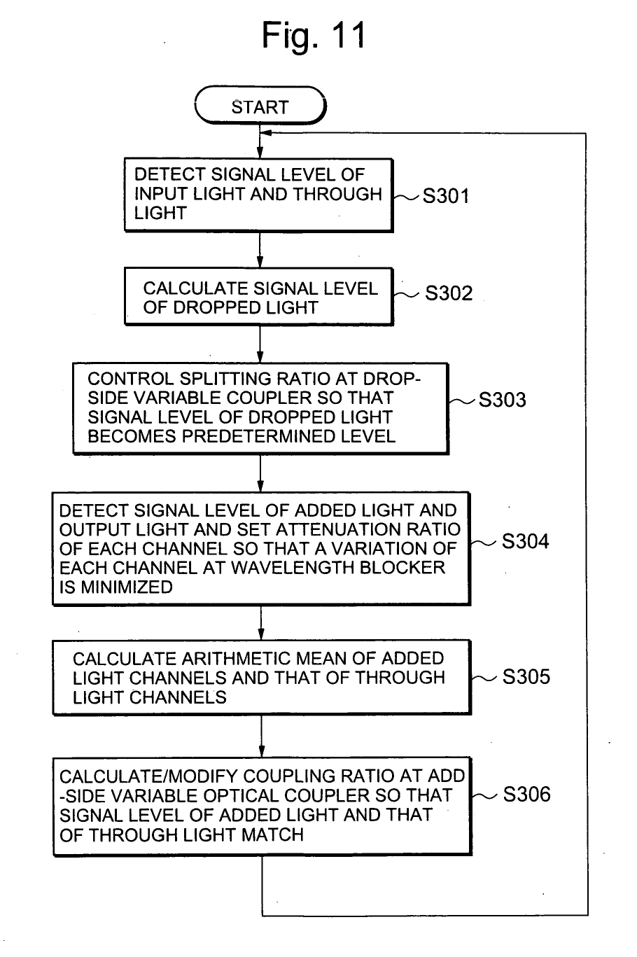

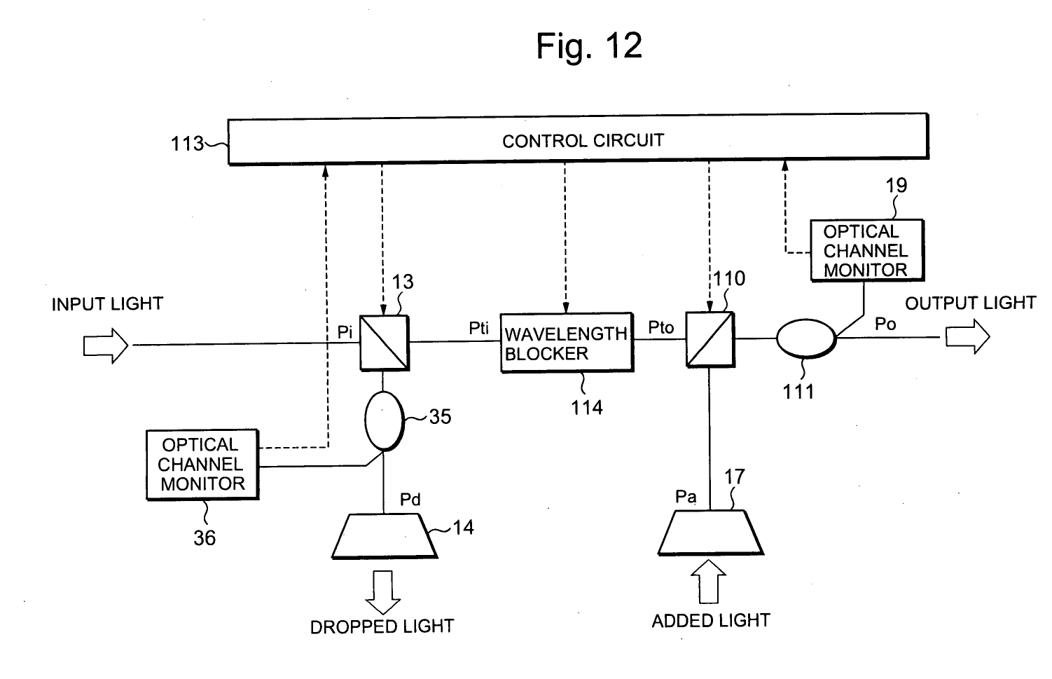

The operation of the optical add/drop system according to this exemplary embodiment is described below. FIG. 11 shows the operation process of the optical add/drop system of this exemplary embodiment.

The result of the optical channel monitor 36 is input to a control circuit 113 (S301). Then, the control circuit 113 calculates an arithmetic mean (Pd) of dropped light channels detected by the optical channel monitor 36 (S302).

The control circuit 113 sends a control-signal for tuning the splitting ratio of the drop-side variable optical coupler 13 to the drop-side variable optical coupler 13, so that the above signal level keeps a preset target value (S303).

The result of the optical channel monitor 19 is input to the control circuit 113. Then, the control circuit 113 sends a control signal to the wavelength blocker 114, so that the a variation among through light of the output light detected by the optical channel monitor 19 is minimized (i.e., so that the variation matches apreset target value) (S304).

Thereafter, the control circuit 113 calculates an arithmetic mean (Poa) of the optical levels of added light channels of the output light detected by the optical channel monitor 19, and an arithmetic mean of the optical levels of through light channels (S305).

Then, the control circuit 113 sends a control signal for tuning the splitting ratio of the add-side variable optical coupler 110 to the add-side variable optical coupler, so that Poa is equal to Pot (S306).

The control circuit 113 repeats the steps of S301 through S306 described above.

In the optical add/drop system according to this exemplary embodiment, the optical channel monitor 12 is only used for determining whether each channel of output light is through light or added light. Since the add-side variable optical coupler 13 only branches input light into through light and dropped light, regardless of wavelengths, channels in the dropped light detected by the optical channel monitor 36 are the same as input light. Therefore, it is possible to omit the tap coupler 11 and the optical channel monitor 12 and to determine whether each channel of output light is through light or added light based on the result of the optical channel monitor 36. This simplifies the configuration of the optical add/drop system.

The optical add/drop system according to this exemplary embodiment detects the drop-side optical level directly with the optical channel monitor, and is able to control more precisely than the optical add/drop system of the first exemplary embodiment.

The exemplary embodiments described above are examples of embodiments of the present invention, and the present invention is not limited to these exemplary embodiments.

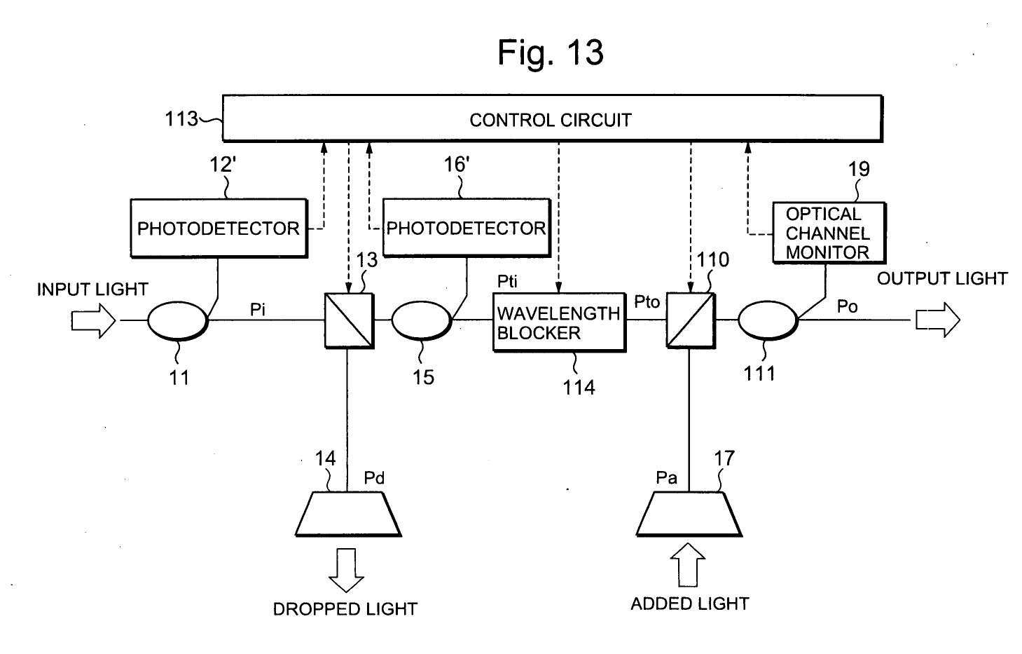

For example, in the aforementioned exemplary embodiments, the level of input light or through light is determined by calculating an arithmetic mean of the intensities of wavelength channel of the light detected by the channel monitor, but the present invention is not restricted to this configuration. For instance, the level of input light or through light may be determined with a photodetector (photodiode or the like) that is wavelength-independent, as shown in FIG. 13. In this case, the measurement value detected by the photodetector is an arithmetic mean of the intensities of wavelengths and therefore arithmetic operations, can be simplified.

While this invention has been particularly shown and described with reference to exemplary embodiments thereof, it will be understood by those skilled in the art that various changes in form and details may be made therein without departing from the spirit and scope of the invention as defined by the appended claims. The above-described exemplary embodiments should be considered in a descriptive sense only and are not for purposes of limitation. Therefore, the scope of the invention is defined not by the detailed description of the invention but by the appended claims, and all differences within the scope will be construed as being included in the present invention.

What we claim is:

1. An optical add/drop device comprising:
a first variable coupler which receives an input optical signal having a plurality of channels and splits the input optical signal to a through optical signal and a dropped optical signal;
a wavelength blocker which attenuates an intensity of each channel of the through optical signal;
a second variable coupler which couples the through optical signal from the wavelength blocker with an added optical signal;
a dropped optical signal detector which measures an intensity of the dropped optical signal that is dropped by the first variable coupler;
an added optical signal detector which measures an intensity of the added optical signal; and
a through optical signal detector which measures an intensity of the each channel of the through optical signal from the wavelength blocker.

2. The optical add/drop device as claimed in claim 1, wherein the dropped optical signal detector measures an intensity of the input optical signal and the intensity of the dropped optical signal is measured by subtracting the intensity of the through optical signal from the intensity of the input optical signal.

3. The optical add/drop device as claimed in claim 2, wherein the dropped optical signal detector measures the intensity of the input optical signal by calculating arithmetic means of channels of the input optical signal, and the through optical signal detector measures the intensity of the through optical signal by calculating arithmetic means of channels of the through optical signal.

4. The optical add/drop device as claimed in claim 1, wherein the through optical signal detector stores the information identifying the wavelengths of the through optical signal from the wavelength blocker, and
wherein the through optical signal detector measures the intensity of the each channel of the through optical signal based on the information that is stored.

5. The optical add/drop device as claimed in claim 4, the through optical signal detector further comprising:
a wavelength splitting device which splits a portion of the through optical signal from the wavelength blocker into each channel according to wavelength; and
an optical signal detector which detects the each channel.

6. The optical add/drop device as claimed in claim 4, the through optical signal detector further comprising:
a diffraction device which diffracts a portion of the through optical signal from the wavelength blocker along the wavelength according to wavelength; and
an optical signal detector which detects the diffracted through optical signal.

7. The optical add/drop device as claimed in claim 6, wherein the diffraction device is a variable diffraction grating capable of changing an amount of diffraction of the through optical signal.

8. The optical add/drop device as claimed in claim 6, wherein the diffraction device is a fixed diffraction.

9. The optical add/drop device as claimed in claim 6, wherein an amount of diffraction of the through optical signal can be controlled by a control signal from outside.

10. The optical add/drop device as claimed in claim 4, the through optical signal detector further comprising:
a band-pass filter which filters a particular wavelength range;
an incident angle controller which controls an incident angle of the through optical signal to the band-pass filter; and
an optical signal detector which detects the light from the band-pass filter.

11. The optical add/drop device as claimed in claim 10, wherein the band-pass filter is a dielectric wavelength variable optical band-pass filter.

12. The optical add/drop device as claimed in claim 10, wherein the band-pass filter is a waveguide variable optical band-pass filter.

13. The optical add/drop device as claimed in claim 1, wherein the added optical signal detector stores the information that identifies the wavelengths of the added optical signal; and
wherein the added optical signal detector measures the intensity of the each channel of the added optical signal based on the information that is stored.

14. The optical add/drop device as claimed in claim 1, further comprising:
an optical amplifier which is provided subsequent to the second variable coupler, and which amplifies an optical signal from the second variable coupler.

15. An optical add/drop device comprising:
a first variable coupler which receives an input optical signal having a plurality of channels and splits the input optical signal to a through optical signal and a dropped optical signal;
a wavelength blocker which attenuates an intensity of each channel of the through optical signal;
a variable attenuator which attenuates an added optical signal;
an optical coupler which couples the through optical signal from the wavelength blocker with the added optical signal from the variable attenuator;
a dropped optical signal detector which measures an intensity of the dropped optical signal;
an added optical signal detector which measures an intensity of the added optical signal; and
a through optical signal detector which measures an intensity of the each channel of the through optical signal from the wavelength blocker.

16. An optical add/drop device comprising:
a first variable coupler which receives an input optical signal having a plurality of channels and splits an input optical signal to a through optical signal and a dropped optical signal;
a wavelength blocker which attenuates an intensity of each channel of the through optical signal;
a second variable coupler which couples the through optical signal from the wavelength blocker with an added optical signal and outputs an output optical signal having a plurality of channels;
an input optical signal detector which measures an intensity of the input optical signal;
a dropped optical signal detector which measures an intensity of the dropped optical signal that is dropped by the first variable coupler; and
an output optical signal detector which measures an intensity of the each channel of the output light from the second variable coupler.

17. An optical add/drop system comprising:
a first variable coupler which receives an input optical signal having a plurality of channels and splits the input optical signal to a through optical signal and a dropped optical signal;
a wavelength blocker which attenuates an intensity of each channel of the through optical signal;
a second variable coupler which couples the through optical signal from the wavelength blocker with an added optical signal and outputs an output optical signal having a plurality of channels;
a dropped optical signal detector which measures an intensity of the dropped optical signal that is dropped by the first variable coupler;
an added optical signal detector which measures an intensity of the added optical signal;
a through optical signal detector which measures an intensity of the each channel of the through optical signal from the wavelength blocker; and
a controller which controls the first variable coupler based on the result of the measurement of the dropped optical signal detector, controls the wavelength blocker based on the measurement of the through optical signal detector, and controls the second variable coupler based on the result of the measurement of the through optical signal detector and the added optical signal detector.

18. The optical add/drop system as claimed in claim 17, wherein the intensity of the dropped optical signal is kept constant to a predetermined value by the controlling process by the controller, the intensity of the each channel of the through optical signal from the wavelength blocker is kept constant to a predetermined value by the controlling process by the controller, and the intensity of the each channel of the output optical signal is kept constant to a predetermined value by the controlling process by the controller.

19. An optical add/drop system comprising:
a first variable coupler which receives an input optical signal having a plurality of channels and splits the input optical signal to through optical signal and dropped optical signal;
a wavelength blocker which attenuates an intensity of each channel of the through optical signal;
a variable attenuator which attenuates an added optical signal;
an optical coupler which couples the through optical signal from the wavelength blocker with the added optical signal from the variable attenuator;
a dropped optical signal detector which measures an intensity of the dropped optical signal;
an added optical signal detector which measures an intensity of the added optical signal;
a through optical signal detector which measures an intensity of the each channel of the through optical signal from the wavelength blocker; and
a controller which controls the first variable coupler based on the result of the measurement of the dropped optical signal detector, controls the wavelength blocker based on the measurement of the through optical signal detector, and controls the variable attenuator based on the result of the measurement of the through optical signal detector and the added optical signal detector.

20. The optical add/drop system as claimed in claim 19, wherein the intensity of the dropped optical signal is kept constant to a predetermined value by a controlling process by the controller, the intensity of the each channel of the through optical signal from the wavelength blocker is kept constant to a predetermined value by the controlling process by the controller, and the intensity of the each channel of the output optical signal is kept constant to a predetermined value by the controlling process by the controller.

21. An optical add/drop method in an optical add/drop system comprising a first variable coupler which receives an input optical signal having a plurality of channels and splits the input optical signal to a through optical signal and a dropped optical signal, a wavelength blocker which attenuates an intensity of each channel of the through optical signal, a second variable coupler which couples the through optical signal from the wavelength blocker with an added optical signal, the method comprising:
measuring an intensity of the dropped optical signal;
adjusting a splitting ratio of the first variable coupler, which splits the through optical signal and the dropped optical signal according to the splitting ration that is adjusted, based on the measured intensity of the dropped optical signal;
measuring an intensity of each channel of the through optical signal;
adjusting an amount of attenuation of the through optical signal by the wavelength blocker based on the measured intensity of each channel of the through optical signal;
measuring an intensity of the added optical signal; and
adjusting a coupling ratio of the second variable coupler, which couples the through optical signal and the added optical signal according to the coupling ratio which is adjusted, based on the measured intensity of the added optical signal.

22. An optical add/drop, method in an optical add/drop system comprising a first variable coupler which receives an input optical signal having a plurality of channels and splits the input optical signal to a through optical signal and a dropped optical signal, a wavelength blocker which attenuates an intensity of each channel of the through optical signal, a variable attenuator which attenuates an added optical signal, and an optical coupler which couples the through optical signal from the wavelength blocker with the added optical signal from the variable attenuator, the method comprising:
measuring an intensity of the dropped optical signal;
adjusting a splitting ratio of the first variable coupler, which splits the through optical signal and the dropped optical signal according to the splitting ration that is adjusted, based on the measured intensity of the dropped optical signal;
measuring an intensity of each channel of the through optical signal;
adjusting an amount of attenuation of the through optical signal by the wavelength blocker based on the measured intensity of each channel of the through optical signal;
measuring an intensity of the added optical signal; and
adjusting an amount of attenuation of the variable attenuator based on the measured intensity of the added optical signal.

23. The optical add/drop method as claimed in claim 21 or 22, said measuring the intensity of the dropped optical signal further comprising:
measuring an intensity of the input optical signal;
measuring an intensity of the through optical signal from the first variable coupler; and
subtracting the intensity of the through optical signal from the intensity of the input optical signal.
